(19) United States
(12) Patent Application Publication
(10) Pub. No.: US 2008/0250310 A1
(43) Pub. Date: Oct. 9, 2008

(54) APPARATUS AND METHOD FOR OPTIMIZING AND DIFFERENTIATING WEB PAGE BROWSING

(75) Inventors: Ying Chen, Beijing (CN); Long Cheng, Beijing (CN); Dong Jun Lan, Beijing (CN); Hai Ping Li, Beijing (CN); Meng Ye, Beijing (CN)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 12/054,625

(22) Filed: Mar. 25, 2008

(30) Foreign Application Priority Data
Mar. 26, 2007 (CN) 20710088954.2

(51) Int. Cl. G06F 3/048; G06F 17/00

(52) U.S. Cl. 715/234

(57) ABSTRACT

An apparatus and method for customizing a web page comprising components and steps for analyzing a template of the web page to obtain block elements constituting the web page template, selecting a block element to be customized, and setting an optimization and/or differentiating policy for the selected block element, thus customizing the selected block element, and storing the customized policy correlated to a selector. The invention also provides an apparatus for optimizing and/or differentiating a web page based on customized policies, which are stored correlated to selectors and web page templates, comprising a web page object selector for comparing the visited original web page and the selectors associated with the customized policies to determine the portion in the web page matched with a selector; and a policy enforcer for enforcing a corresponding policy on said matched portion, thus displaying an optimized and differentiated web page.

### TECHNICAL FIELD

The present invention relates to customization of a web page, in particular to optimization and differentiation of a web page. Specifically, the invention relates to an apparatus and a method for optimizing and differentiating web page browsing, and a program product for realizing said method.

### BACKGROUND ART

There are million of web sites within the internet. Moreover, more and more people depend on some of the web sites for their daily work and life. They navigate these web sites maybe many times one day, to browse news, search information, download resources, or communicate with others. It is valuable that users can customize and optimize the web sites they frequently visit according to their preference, which will improve the speed and benefit the user experience. Considering the content of these web sites/channels, this kind of optimization can be better done in a semantic manner, that is, the optimization can be conducted by considering the contents.

Currently the customization and optimization is mainly through the server side user information management. There are web site optimization services to improve the performance. However they are server side technology and are not user-centric, because the preferences of an end user are not taken into account in the optimization process. For customization, there are often user account databases and verification modules within the server side. Typically, users have to set up an account within the server side, customize the web site and save their customization, using the rare function provided by the web application. These customization functions are often not satisfactory. Every time, users have to log on to the web site and after logon the customization can take effect. It also brings great pressure to an application server, especially in the peak hours when many users visit simultaneously. Many web sites, such as new sites, don't provide the functionality of customization. On the client side, a user can modify some parts from the client browser, i.e., the font, the text color, etc. However these functions are limited and usually do not involve modifying the behavior of a web site or a channel, unless a user is a developer who is familiar with html, script language. In these conditions, although users visit the web sites everyday, there are no convenient means to change some of the behavior.

### SUMMARY OF THE INVENTION

A method and system to enable end user-centric optimized browsing and differentiated browsing to improve web site performance and experience is presented in this invention. It is briefly composed of two phases. Phase one is to create a personalized profile repository. Phase two is to optimize and customize the browsing based on the profile repository, during which original web pages are transformed into customized and optimized ones, and differentiated browsing is enabled based on the content and user preference.

Specifically, the invention provides an apparatus for customizing a web page, comprising: a block analyzer for analyzing a template of the web page to obtain block elements constituting the web page template; customizing means for selecting a block element to be customized, and setting an optimization and/or differentiating policy for the selected block element, thus customizing the selected block element; and policy storing means, for storing the customized policy correlated to a selector.

The invention also provides an apparatus for optimizing and/or differentiating a web page based on customized policies, which are stored correlated to selectors and web page templates, the apparatus comprising: a web page object selector for comparing the visited original web page and the selectors associated with the customized policies to determine the portion in the web page matched with a selector; and a policy enforcer for enforcing a corresponding policy on said matched portion, thus displaying an optimized and differentiated web page.

The invention also provides a method for customizing a web page, comprising steps of: analyzing a template of the web page to obtain block elements constituting the web page template; selecting a block element to be customized, and setting an optimization and/or differentiating policy for the selected block element, thus customizing the selected block element; and storing the customized policy correlated to a selector.

The invention further provides a method for optimizing and/or differentiating a web page based on customized policies, which are stored correlated to selectors and web page templates, the method comprising steps of: comparing the visited original web page and the selectors associated with the customized policies to determine the portion in the web page matched with a selector; and enforcing a corresponding policy on said matched portion, thus displaying an optimized and differentiated web page.

Also provided are programs for enabling a computer to perform either of the above methods, and a storing medium with such program stored therein.

Compared with the user profile based approach, the system doesn't require setup of a user account for each user in the database on the server site. Users can customize the web site, or channel they visit through the policy storing means within the client site. The system and method decreases the workload of the application server and makes it capable of supporting more users concurrently using the same infrastructure. Moreover, the method and system helps users to on-demand optimize their visit to the web site. The optimization is not only the view of the web page, but also the behavior of the web site, through the policies that the users pre-define. It also helps users to actively protect against malicious web documents. Since the method and system is template based and block based, users can extract the template from the site/channel they frequently visit, and customize the block they'd like to visit and wouldn't like to visit, through the automatically enforced runtime module of the system.

### BRIEF DESCRIPTION OF THE DRAWINGS

The invention will be described in detail with reference to the accompanying drawings, wherein:

FIG. 1 is a block diagram illustrating a system comprised of a preferred embodiment of a customizing apparatus according to the invention and a preferred embodiment of a customization application apparatus according to the invention;

FIG. 2 is a flow chart illustrating a preferred embodiment of a customizing method according to the invention;

FIG. 3 is a flow chart illustrating a preferred embodiment of a customization application method according to the invention.

### DETAILED DESCRIPTION OF PREFERRED EMBODIMENTS

Firstly, preferred embodiments of the customizing apparatus according to the invention and the customization application apparatus according to the invention will be described below with reference to the accompanying drawings.

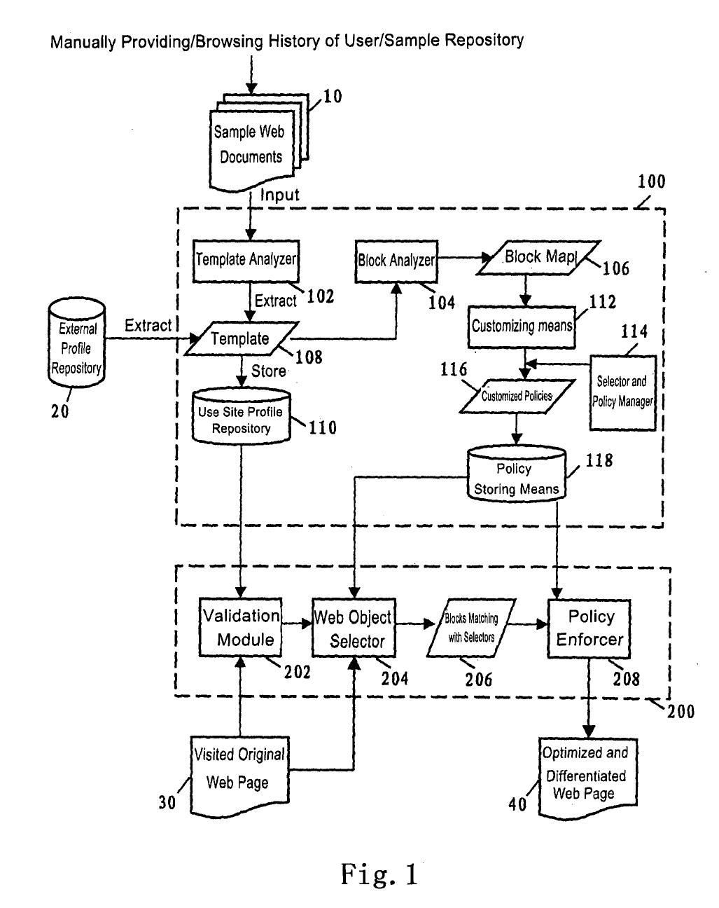

FIG. 1 is system diagram of the customizing and differentiating apparatus according to the invention. The apparatus may comprise two parts, one of which is a customizing apparatus 100, and the other is an apparatus 200 for applying customizations. As shown in FIG. 1, the customizing apparatus 100 together with the customization application apparatus 200 constitute a system which customizes policies 116 based on sample web documents 10 or templates 108 from an external profile repository 20, and applies the policies to an original web page 30 to be visited, thus obtaining a customized and differentiated web page 40.

However, the customizing apparatus 100 and the customization application apparatus 200 may also be implemented separately. Some users may customize a policy using the customizing apparatus 100 and the other users may, by using the customization application apparatus 200, apply a policy customized by others to a web page they hope to visit. One scenario that may be contemplated is that a third party service provider customizes various policies adapted to various web sites, channels and web pages by using the customizing apparatus 100 and provides the policies to final users. When visiting a web page, a final user may, by using the customization application apparatus 200, apply the policies provided by the third party service provider to the web page to be visited.

The customizing apparatus 100 and the customization application apparatus 200 will be further described below in detail with reference to the accompanying drawings. Note that although FIG. 1 illustrates all the components of a preferred embodiment according to the invention, depending on specific condition not all of the components are necessary, which will be pointed out in the following description of these components.

As shown in FIG. 1, the customizing apparatus 100 may include the following components: a template analyzer 102, a user site profile repository 110, a block analyzer 104, a customizing apparatus 112, a selector and policy manager 114 and policy storing means 118. The customization application apparatus 200 may include the following components: a validation module 202, a document object selector 204 and policy enforcer 208.

Below will be described the above-mentioned components and the external profile repository 20.

As shown in FIG. 1, in the customizing apparatus 100, sample web documents 10 may be taken as the input, from which the template analyzer 102 extracts a template of the site or of the specific channels that the sample web documents belong to. The template is then stored into the user site profile repository 110. The block analyzer 104 helps users specify which blocks within the web document they'd like to customize, using the profile and the web documents as input. Based on the selected blocks, the selector and policy manager 114 controls the customization users can specify. It separately records the block context information as the selector and the customization information as policies. These records are finally stored into the policy storing means 118.

Sample web document 10 is the original data set of a web document. A sample web document provides a start for users to interactively customize the web site or the channel which sample web document belongs to. The user specifies a web site or a channel they want to customize and provides a sample web document as the example. Typically, in order to extract a template, more than one sample is needed. The additional samples are retrieved either from the user's browsing history or from the sample web document database, if the URLs match that of the target site (channel). If there is no match, the user needs to manually provide the additional samples. The sample web documents serve as the input to the template analyzer and block analyzer.

Template analyzer 102 is used to extract a template 108 from sample web document 10 for a web site or channel. The web site or the channel is the collection of web pages. They have a specific template and, therefore, share a common look and feel. The template is the pre-prepared master web page that is used as a basis for composing new web pages. When a template is displayed on a display, it is a framework obtained by removing all the contents from a complete web page. The framework is comprised of different blocks, such as a word block into which words are to be filled, an image block in which an image is to be displayed. In other words, in a web page or a web page template, a “block” corresponds to tags indicating which content should be displayed in which position. All such tags in a web page constitute a template. For a plurality of sample web documents, those tags are the same among said plurality of sample web documents and constitute a template shared by the plurality of sample web documents. Note, there are two kinds of templates within the web document. The first is the common Cascaded Style Sheet template, which defines the generic presentation across the site or channel. The other is the template within the web page, which is extracted through a comparison process of the samples provided. Most web sites contain both of them. However some old style web sites might contain only the latter. For the first kind of template, the template analyzer 102 may extract it directly from a website, that is, download a CSS (Cascaded Style Sheet) file. For the second kind of template, a template may be extracted by simply comparing at least two sample web documents. In this regard, reference may be made to the following description about the method according to the invention.

User site profile repository 110 is used to store the generated templates 108. Since it is necessary to identify different templates, the templates are stored in the form of a profile. Each record of a profile may contain one or more of the following items: name, user, site, channel, template and CSS. The name field is unique to distinguish different records. The user field is used to identify the user account that owns the record, which means that the web browser can maintain various profiles for different users. If there is only one user, then the user field is unnecessary. The site field indicates the web site that the profile belongs to. Similarly, if there is only one website, then the site field is unnecessary. A site might have multiple channels, i.e., news, sports. For multiple channel sites, each channel may have a different template and style, which is indicated through the channel field. If there is only one channel, then the channel field is unnecessary. The template and CSS is the shared content across the site and channel.

The foregoing has described how to extract a template 108 from sample web documents 10. However, a template 108 may also be provided by a third party. In the invention, the source of the template provided by a third party is represented by an external profile repository 20. The external profile repository 20 is similar to a user site profile repository 110, storing templates of web site/channel. The difference is that the profiles are provided by a third party provider. For example, a third party service provider provides the profile record of the web site (channel) that a user would like to customize. Users download the profiles from the third party provider instead of generating them themselves. In some instances, the web site owner might also want to publish the profile of their site and have others customize freely. In these conditions the profiles are queried through the service provided by the web site owner.

The third party may provide a great number of templates, not all of which, possibly, are necessary for each user. In addition, it is possible that these templates are not located in a local site, but in a remote server. Therefore, when a user obtains a template he needs from the external profile repository 20, the template may be stored in the user site profile repository 110 for future use. Certainly, if convenient, the external profile repository may be used as the user site profile repository or a portion thereof.

After the template 108 is obtained, a block analyzer 104 analyzes the template and a web page, to obtain a block map 106 of the web page. A block in a web page template is a portion marked by elements representing a block display style. For example, in the HTML language, such elements include <div>, <ul>, <dl>, <ol>, <table>, <tr>, <td>, <p>, <h1˜6>, <frame>, etc. Therefore, detecting blocks in a template is just detecting the tag elements in the script of a web page. That is, the block analyzer 104 extracts the tags of different constitutive portions (that is, blocks) from a template, thus obtaining information about these portions. The so-called block map is equivalent to a web page displayed with the contents removed, as mentioned above. Certainly, for the sake of easily perceiving, different blocks may be displayed in different manners, or a block may be displayed with some or all of the contents in any sample web document. The target of user customization may be a block element in a web page, instead of an in-line element or text. As discussed above, based on the web site/channel template, the web page can be divided into template information and content information. A user can customize each block within the template, while for content information, the user can only customize the entire block as a whole because the content information might be totally different from page to page.

After obtaining the block map 106 of a web page, a customizing means 112 may set a block of interest for optimization and differentiation thereof or set relevant policies for improve the performance of a web site and the experiences of a user, including base page optimization, graphics and multimedia optimization, script optimization, control optimization, presentation optimization, etc.

Base page optimization: block visible or not option, etc.

Graphics and multimedia optimization: download or not option, play or not option, download level (priority level) option, etc.

Script optimization: download or not option, execute or not option, download level option, etc.

Control optimization: download level option, forced parallel download option, etc.

Presentation optimization: presentation level (priority level) option, keep focus option, etc.

The customizing means may be set totally manually. For example, the setting information may be directly input according to certain syntax. As a preferred embodiment, a selector and policy manager 114 may be provided for assisting the customizing means 112 so that the customizing apparatus according to the invention is user-friendly. The manager 14 controls and records the customization rule users can make on a web site or channel. Here two kinds of information are kept for each rule. The first is the selector, which defines what tags or element within a web page that the rule is applied to. The other is the policy, which defines what customization is supported and can be specified. The selector might be the class or ID of a web element, or the context information within the web document. Sample policies that can be defined include, “not download video within block”, “not download image within block”, “not display block”, etc. As a specific embodiment, the manager may display tags or elements available to be customized (in the form of, for example, a list or a pull-down menu) when a user selects a block in a block map. At the same time, or after the user has selected tags or elements to be customized, corresponding policies available to be selected may be displayed (in the form of, for example, a list or a pull-down menu). Policies include two kinds, differentiating policies and optimizing policies. A differentiating policy reflects the preference of a user and includes download level or display level, etc., and may assign to a block some other styles, such as background color, font, etc. An optimizing policy relates to optimization of the view or the control of a web page.

The policy storing means 118 is used to record the customization that a user has made for future use. Each record within the policy storing means is linked to a user site profile record within user site profile repository. Each record contains the following fields, name, user site profile name, selector and policy. Name is the unique identifier of the rule. User site profile name specifies which web site (channel) the rule will be applied to. Selector defines what tag/element within the web page the policies will be applied to. Policy indicates the detail information of the rule. Note multiple policies can exist within the same record. Multiple personalized profiles can correspond to the same user site profile record, applied in a specific order.

It can be seen from above that the selectors, policies and user site profile records (that is, web page template) are correlated. Therefore, the user site profile repository 110 and the policy storing means 118 may be merged into one database (not shown in FIG. 1).

With the policies customized by the above described components, when a user tries to visit an original web page 30, the validation module 202 obtains the URL of the original web page 30 and queries the user site profile repository 110 using the URL to see whether the original web page has ever been customized. If the URL exists in the user site profile repository 110, it means the original web page has been customized. As mentioned before, if the user site profile repository 110 differentiates different users, then the query also includes user information, that is, the user site profile repository 110 is queried for entries comprising both the URL and the corresponding user information. If hit, that means the corresponding user customized the original web page. If the original web page has ever been customized, then the other components are called to enforce the corresponding customization policies. The validation module may also check the revision date of the web page and compare the original web page with the stored web page template, to see whether the original web page has changed since the template was generated. If there has been any change, then the validation module updates the template and verifies whether the policies based on the original template are still valid, for example, whether the customized block still exists or whether the nature of the block has changed. The validation module 202 provides the user with information about the changes.

As mentioned before, as to templates obtained from a third party, including the visited web site itself, the templates may be stored in an external profile repository owned by the third party, instead of locally at the user site. In such a case, validation is conducted to the external profile repository, and, if the validation result is positive, then it is necessary to download the template to the local site (not shown). However, since an external profile repository may contain a great number of templates and it is possible that a specific user does not customize all the templates, it is necessary for the validation to access the policy storing means, to determine whether the visited web page has corresponding policy customization information.

The document object selector 204 obtains all the records in the policy storing means that correspond to a web page template firstly (as mentioned above, the web page template may be stored in the policy storing means or in a separate user site profile repository). Then, during parsing of the web page, the document object selector 204 matches the selectors in the records with the parsed web page objects. Only those matched portions have corresponding rules applied to them.

The policy enforcer 208 controls retrieval and display of a web page according to the customized policies. An original web page is transformed by the policy enforcer to a customized web page. The transformation includes retrieval and displaying of the web page according to predetermined customization rules of the web site or channel. For example, if a policy “Do Not Display the Image in the Image Block” is translated, then the browser will not activate any new request for obtaining the image in the block, while the images in the other blocks such as content blocks will still be downloaded and displayed. As an example, other styles, such as background color, font and etc., may be designated for a block in the policy. Such new styles have higher priority than the original styles of the original web page.

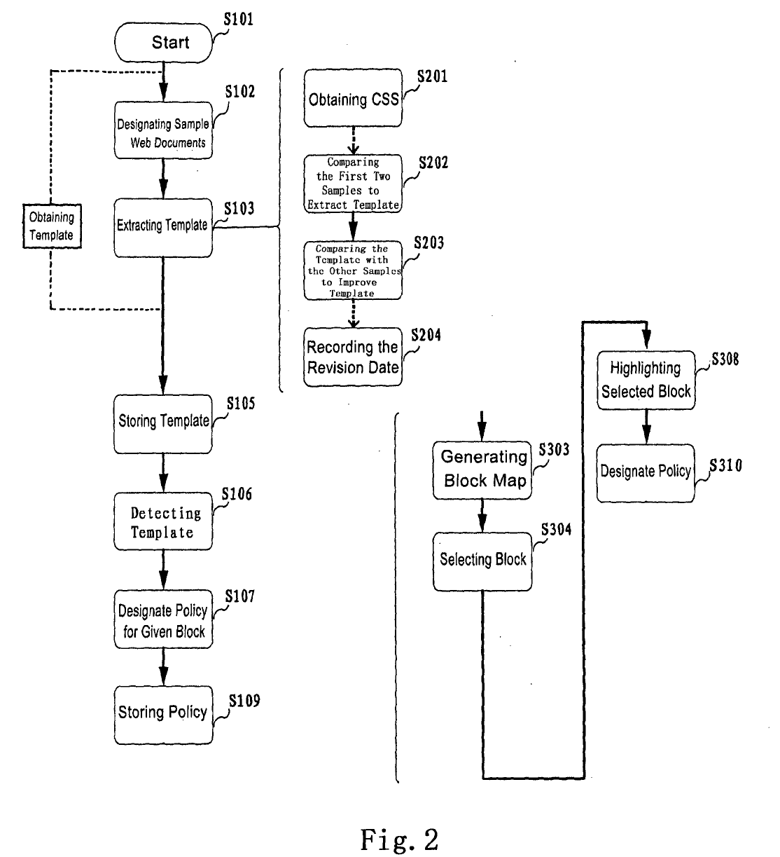

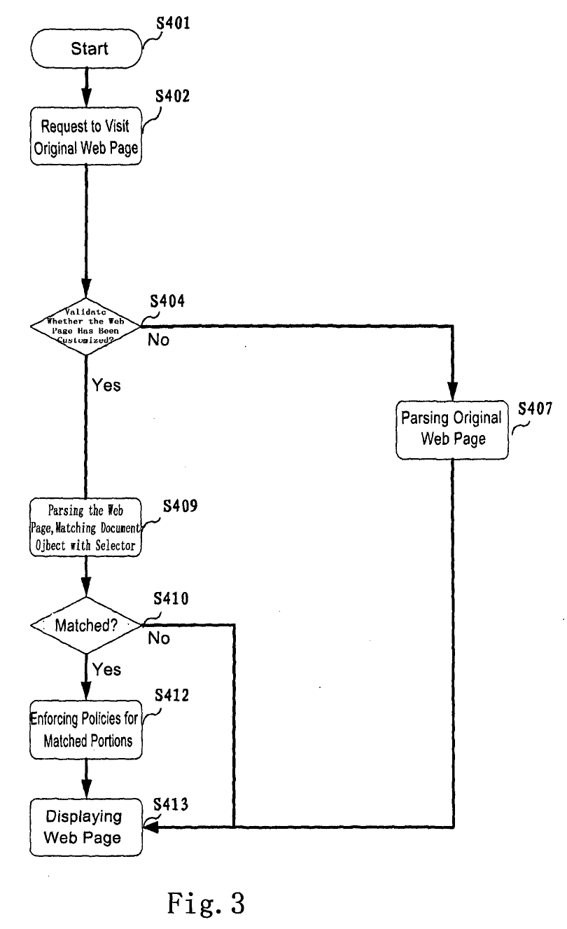

Below the preferred embodiments of the customizing method according to the invention and the customization application method according to the invention will be described with reference to FIG. 2 and FIG. 3.

The method according to the invention comprises a customizing method and a customization applying method, which could be implemented in combination or separately. That is, some users may customize a policy using the customizing method according to the invention (as shown in FIG. 2), and the other users may, by using the customization applying method of the invention (as shown in FIG. 3), apply a policy customized by others to a web page they hope to visit. One scenario that may be contemplated is that a third party service provider customizes various policies adapted to various web sites, channels and web pages and provides the policies to final users. When visiting a web page, a final user may, by using the customization applying method of the invention, apply the policies provided by the third party service provider to the web page to be visited.

Again, note that although FIG. 2 and FIG. 3 illustrate all the steps of a preferred embodiment according to the invention, depending on specific condition, not all of the steps are necessary, which will be pointed out in the following description of these steps.

Below will be firstly described a preferred embodiment of the customizing method according to the invention with reference to FIG. 2

As shown in FIG. 2, the customizing method according to the invention begins with Step S101. Firstly, sample web documents are provided (Step S102). The sample web documents may be provided by the user, may be obtained from the browsing history of the user, or may be obtained from a sample database. Then, in Step S103, a template is extracted from the sample web documents.

There are two kinds of templates. The first is the common Cascaded Style Sheet to which the sample web documents are linked and which define the generic presentation across the site or channel. Such templates may be extracted directly from a web site (Step S201). The other is the template within the web page, which may be extracted through a comparison process of the samples provided. That is, the identical portions shared among different sample web documents constitute a template. For example, the frameworks of the web page scripts comprised of tags may be compared to each other and the shared portions may be regarded as a template. Most web sites contain both of them. However some old style web site might contain only the last one. In such a case, there will be no Step S201 in FIG. 2.

The comparison for extracting template may be conducted in a conventional manner and there are many ways. For example, it is possible to firstly compare two samples (such as the first two samples) (Step S202) thus obtaining a preliminary template. Then the preliminary template may be further compared with more samples and thus obtain a more precise template (Step S203). In a preferred embodiment, for ease of determining whether the template at the time of applying a customized policy is just the template at the time of customizing the policy, and thus determining whether the customized policy is still valid (reference may be made to the description below about the customization applying method), the revision date of the template may be recorded (Step S204). In addition, it should be noted that Step S201 does not necessarily precede Steps S202 and S203.

The template may also be provided by a third party or the visited web site itself. In such a case, the Steps S102 and S103 are replaced with Step S104 for obtaining templates from said third party or the visited web site.

The extracted template may be stored (Step S105) for future use. The template obtained from the third party (including the visited web site itself) may also be stored locally in the user site for future use, but it may also be stored remotely and need to be downloaded from the third part again when the template is used later.

The next step is to detect blocks in the template (Step S106). As mentioned before, a block in a web page template is a portion marked by elements representing a block display style. For example, in the HTML language, such elements include <div>, <ul>, <dl>, <ol>, <table>, <tr>, <td>, <p>, <h1˜6>, <frame>, etc. Therefore, detecting blocks in a template is detecting the tag elements in the script of a web page.

The step S107 for customizing a policy is conducted on a block basis because, for a policy to be applicable for a long time, it must be adapted to the framework of the webpage not to the specific contents therein, which are changing.

The right side of FIG. 2 illustrates a preferred embodiment of the Step S107. For facilitating the user's customization, a block map showing all the blocks in a web page may be generated firstly (Step S303). The user selects blocks to be customized in the displayed block map (Step S304). For convenience of the user, the selected clock may be highlighted (Step S309). Then policies are assigned to selected blocks (Step S310). Assignment of policies may be conducted through direct input or though a list of potential policies from which selection is made. Any conventional way for selecting an object or text may be adopted to select the blocks. For example, when clicking somewhere within a block, then the block is selected. Alternatively, a block may be selected by selecting its contents, and a block may be regarded as have been selected when the selected contents in the block exceed a predetermined ratio, or the like.

Having been customized, the policies need to be stored (Step S109). The policies and the web page templates may be stored in different locations or the same location, but they should be stored in a correlated manner.

The customizing method has been described above with reference to FIG. 2. Below the customization applying method according to the invention will be described with reference to FIG. 3.

As shown in the drawing, the customization applying method of the invention begins with the step S401. Firstly, a user requests to visit a web page, called the original web page (Step S402). At that time, it is necessary to firstly validate whether the web page has ever been customized (Step S403). Corresponding to the customizing method of the invention, the local user site may be searched to determine whether the template of the web page is stored. If yes, then it means the template has been customized. However, as mentioned before, it is possible that the template is provided by a third party, or is extracted or downloaded and stored by the user, but has not been customized.

If the validation result shows no customization, then the original web page is parsed (Step S407) and displayed (Step S413). If the validation result shows that customization has ever been made, then the web page is parsed at the same time, the objects in web page document are matched with the selectors corresponding to the stored policies (Step S409). If a document object matches a selector (determining step S410), then the policy corresponding to the selector is enforced on the matched document object (Step S412), thus the object is processed (downloaded, displayed and etc.) according to the customized policy; otherwise the object is processed directly.

For a person skilled in the art, it could be understood that any or all of the steps/components of the method and apparatus according to the invention may be implemented in form of hardware, firmware, software of any combination thereof in any computing equipment (including a processor and storing media and etc.) or any network of computing equipments, and could be realized by the basic programming skills of any person skilled in the art having read the description of the invention, and more detailed description is omitted here.

Furthermore, in the above description, when concerning operations such as selecting, designating and so on, it is obviously necessary to use a display device and an input device connected to computing equipment, corresponding interfaces and controller software. Relevant hardware and software in a computer, a computer system or a computer network, along with hardware, firmware or software implementing the operations in the method of the invention described above, or any combination thereof, constitute the apparatus of the invention and components thereof.

Therefore, based above understanding, the object of the invention may also be achieved by one application or one group of applications running on any information processing equipment, which may be well-known universal equipment. Therefore, the object of the invention may also be achieved by simply providing a program product comprising program codes capable of realizing the method or apparatus as described above. That is to say, such a program product constitutes the invention, and any storing media with such a program product stored therein also constitutes the invention. Obviously, said storing medium may be any well-known storing medium or any storing medium developed in the future, therefore it is unnecessary to list all the storing media here.

In the method and apparatus according to the invention, obviously, the component or steps may be decomposed and/or re-combined. The decomposition and/or recombination shall be regarded as equivalents of the invention.

Preferred embodiments according to the invention have been described above. A person skilled in the art will understand that the protection scope of the invention is not limited to the specific details disclosed herein, which may have various variations and equivalents within the spirit of the invention.

1. An apparatus for customizing a web page, comprising:
a block analyzer for automatically analyzing a template of the web page to obtain block elements constituting the web page template;
customizing means for selecting a block element to be customized, and setting at least one of an optimization and a differentiating policy for the selected block element, thus customizing the selected block element; and
policy storing means, for storing the customized policy correlated to a selector.

2. The apparatus of claim 1, further comprising:
a template analyzer for analyzing samples of the web page to be optimized and differentiated to extract a template of the web page as input to said block analyzer.

3. The apparatus of claim 1, further comprising:
a selector and policy manager for managing selectors for selecting customization objects and to-be-selected optimization and differentiating policies corresponding to said selectors;
wherein, for the block selected to be customized, said selector and policy manager lists potential selectors and corresponding policies and said customizing means makes selection from said list and completes customization.

4. The apparatus according to claim 1, further comprising:
a user site profile repository for storing at least one web page template customized by a user;
wherein said policy storing means stores at least one policy corresponding to said at least one web page template.

5. The apparatus according to claim 1, wherein said policy storing means stores at least one policy and corresponding web page templates correlated thereto.

6. The apparatus according to claim 1, wherein said block analyzer is configured to detect element tags in a script of the web page template to obtain block elements constituting the web page template.

7. The apparatus according to claim 2, wherein said template analyzer is configured to compare scripts of sample web documents and identify identical portions shared among different sample web documents as said template.

8. An apparatus for optimizing and differentiating a web page based on customized policies, which policies are stored correlated to selectors and web page templates, the apparatus comprising:
a web page object selector for comparing a visited original web page and selectors associated with the customized policies to determine a portion in the web page matched with a selector; and
a policy enforcer for enforcing a corresponding policy on said matched portion, thus displaying an optimized and differentiated web page.

9. The apparatus of claim 8, further comprising:
a validation module for validating whether a web page template matched with the visited original web page has been stored, thus determining whether a policy related to the visited original web page exists;
wherein, when the validation module confirms there exists a policy related to the visited original web page, the web page object selector retrieves said policy related to said web page template, compares the visited original web page and the selector associated with the retrieved policy, and determines the portion matched with the selector.

10. The apparatus of claim 9, wherein the validation module is further configured to update the web page template according to the changes in the visited web page, verify whether the policies based on the original template are still valid, and provide relevant information to the user.

11. The apparatus according claim 9, wherein the validation module is configured to query the stored web page template using URL wherein the existence of a stored web page template having a corresponding URL indicates whether the original web page has ever been customized.

12. A method for customizing a web page, comprising steps of:
analyzing a template of the web page to obtain block elements constituting a web page template;
selecting a block element to be customized, and setting at least one of an optimization and differentiating policy for the selected block element, thus customizing the selected block element; and
storing the customized policy correlated to a selector.

13. The method of claim 12, further comprising a step of:
analyzing samples of the web page to be optimized and differentiated to extract a template of the web page.

14. The method of claim 12, wherein:
for the block element selected to be customized, listing potential selectors and corresponding policies, for selection and completion of customization.

15. The method according to claim 12, wherein the web page templates and customized policies are stored correlated to each other.

16. The method according to claim 12, wherein said step of analyzing the web page template comprises detecting the element tags in a script of the web page template to obtain the block elements constituting the web page template.

17. The method according to claim 13, wherein said step of extracting a web page template comprises comparing scripts of sample web documents, wherein identical portions shared among different sample web documents constitute said template.

18. A method for optimizing and differentiating a web page based on customized policies, which are stored correlated to selectors and web page templates, the method comprising the steps of:
comparing the visited original web page and the selectors associated with the customized policies to determine the portion in the web page matched with a selector; and
enforcing a corresponding policy on said matched portion, thus displaying an optimized and differentiated web page.

19. The method of claim 18, further comprising a validation step for validating whether a web page template matched with the visited original web page has been stored, thus determining whether a policy related to the visited original web page exists;
wherein, when the validation step confirms there exists a policy related to the visited original web page, retrieving said policy related to said web page template, comparing the visited original web page and the selector associated with the retrieved policy, and determining the portion matched with the selector.

20. The method of claim 18, further comprising: updating the web page template according to changes in the visited web page, verifying whether the policies based on the original template are still valid, and providing relevant information to a user.

21. The method according claim 19, wherein the validation step comprises querying the stored web page template using URL and wherein the existence of a web page template having a corresponding URL indicates whether the original web page has ever been customized.
